(19) United States
(12) Patent Application Publication
(10) Pub. No.: US 2003/0130602 A1
(43) Pub. Date: Jul. 10, 2003

(54) Massaging assembly having various massaging members

(76) Inventor: Horng Jiun Chang, Chang Hua Hsien (TW)

Correspondence Address: CHARLES E. BAXLEY, 59 John Street - 5th Floor, New York, NY, 10038, US

(21) Appl. No.: 10/041,276

(22) Filed: Jan. 10, 2002

(51) Int. Cl. A61H 1/00

(52) U.S. Cl. 601/49; 601/70; 601/78

(57) ABSTRACT

A massaging device includes a massaging member having a number of upper rods for engaging with and for massaging users, and a number of reinforcing ribs for reinforcing purposes. A peripheral handle device has two hand grips, a motor is secured on the handle device and coupled to an eccentric member for rotating the eccentric member to generate a vibration. A casing may be secured to the motor with one or more cushioning members. One or more further massaging members may be detachably secured onto the casing and each has a tip, or a cap for massaging different portions of the users.

### BACKGROUND OF THE INVENTION

1. Field of the Invention

The present invention relates to a massaging assembly, and more particularly to a massaging assembly for massaging various portions of the users.

2. Description of the Prior Art

Various kinds of typical massaging devices have been developed and used today, and comprise an eccentric member of cam device rotated or driven by a motor in order to generate a vibration to the massaging members. Some of the typical massaging devices may be used for massaging the bodies of the users, but may not be used for massaging the feet of the users. The other typical massaging devices may be used for massaging the feet of the users, but may not be used for massaging the bodies of the users. The massaging devices may not be used for massaging various portions of the users.

The present invention has arisen to mitigate and/or obviate the afore-described disadvantages of the conventional massaging devices.

### SUMMARY OF THE INVENTION

The primary objective of the present invention is to provide a massaging assembly including various kinds of massaging members for massaging various portions of the users.

In accordance with one aspect of the invention, there is provided a massaging assembly comprising a first massaging member including an upper portion having a plurality of rods for engaging with and for massaging users, and including a bottom portion having a plurality of reinforcing ribs for reinforcing purposes, and means for vibrating the first massaging member to massage the users.

A handle device is further provided and includes a pair of hand grips provided therein, and includes a peripheral structure having the hand grips provided therein and opposite to each other.

The vibrating means includes a motor, an eccentric member secured to and driven by the motor, and means for securing the motor on the handle device. The securing means includes a housing secured on the handle device and having a chamber formed therein for receiving the motor.

The handle device includes at least one depression formed therein, the housing includes at least one leg extended therefrom and engaged into the depression of the handle device and secured to the handle device.

The vibrating means includes a casing, and at least one cushioning member secured between the casing and the motor. The eccentric member includes an axle rotatably secured to the casing, and includes a protrusion extended therefrom, the motor includes a spindle secured to the eccentric member for rotating the eccentric member.

The vibrating means includes a board secured to the casing and having an orifice formed therein for receiving the eccentric member. The casing includes at least one concave surface formed therein for engaging onto and for massaging the users.

One or more second massaging members are further provided and detachably secured onto the casing. The second massaging members each includes a tip extended therefrom for deeply engaging into the users.

The second massaging members may each include a block, and a cap selectively secured onto the block, the cap includes a head provided thereon for engaging with and for massaging the users.

At least one third massaging member is further provided and selectively engaged onto the head of the cap and includes a plurality of rods extended therefrom for engaging with and for massaging the users.

The cap includes a peripheral groove formed therein, the third massaging member includes at least one spring-biased projection extended therefrom for engaging into the peripheral groove of the cap and for detachably securing the third massaging member onto the cap. The block includes at least one magnetic member disposed thereon.

The first massaging member includes at least one hub provided in the bottom portion thereof for engaging onto the second massaging member, the reinforcing ribs are engaged with the hub.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a massaging assembly in accordance with the present invention;

FIG. 2 is a partial exploded view illustrating one of the massaging members of the massaging assembly;

FIG. 3 is a plan view illustrating the massaging members of the massaging assembly as shown in FIG. 2;

FIGS. 4, 5, 6, 7, 8 are perspective views illustrating the operations of the massaging assembly; and

FIG. 9 is a bottom perspective view of another massaging member of the massaging assembly.

### DETAILED DESCRIPTION OF THE PREFERRED EMBODIMENT

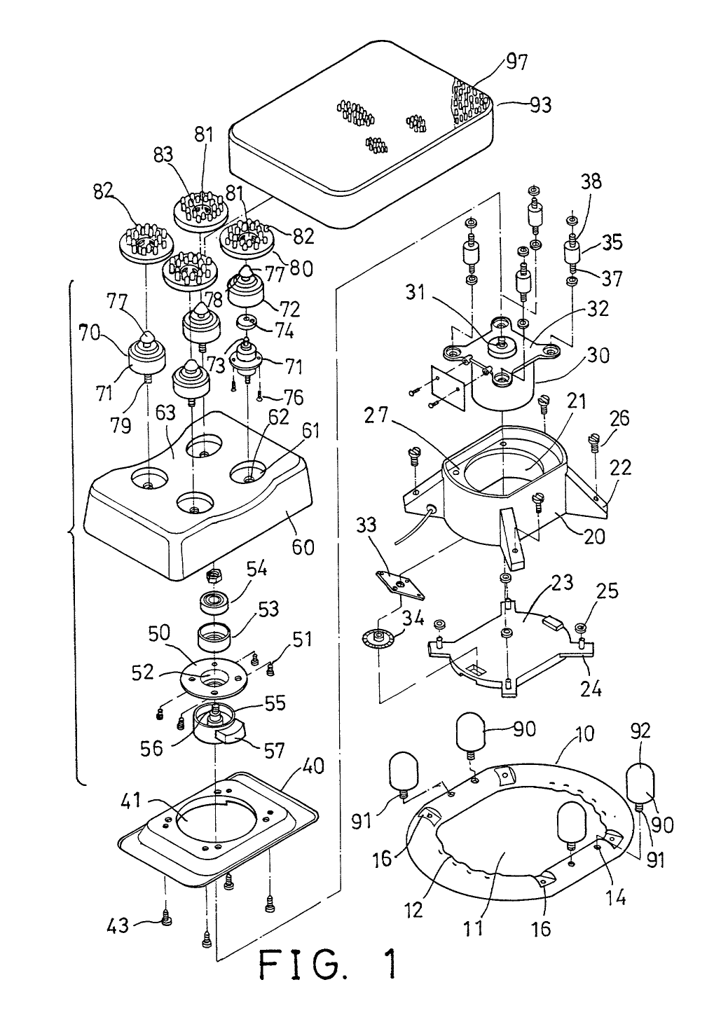

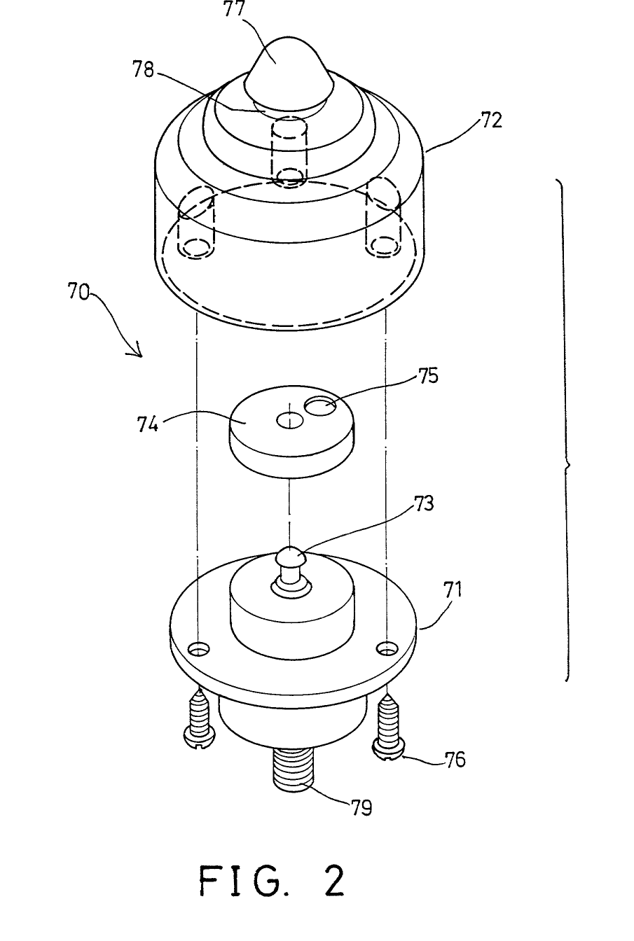

Referring to the drawings, and initially to FIGS. 1-4, a massaging assembly in accordance with the present invention comprises a peripheral handle device 10 including an opening 11 formed therein, and including a pair of opposite hand grips 12 provided thereon, and including one or more, such as two pairs of depressions 16 formed therein, and spaced away from the hand grips 12 thereof. The handle device 10 further includes one or more screw holes 14 formed therein, and also spaced away from the hand grips 12 thereof. One or more massaging members 90 each includes a fastener 91 extended therefrom for detachably threading and securing to the screw holes 14 of the handle device 10, and each includes a rounded or semi-spherical end 92 for comfortably engaging with various portions of the users.

A housing 20 includes a chamber 21 formed therein for receiving a motor 30 therein, and includes one or more, such as four legs 22 extended therefrom and engaged into the depressions 16 of the handle device 10 and secured to the handle device 10 with fasteners 26 or the like. A cover 23 includes four extensions 24 extended therefrom and engaged with the legs 22 of the housing 20 and secured to the legs 22 with fasteners 25 or the like, for retaining the motor 30 within the housing 20. The housing 20 includes an inner peripheral flange 27 extended inward of the chamber 21 thereof. The motor 30 includes a spindle 31 and includes a plate 32 engaged on and secured to the peripheral flange 27 of the housing 20 with fasteners or the like.

For example, as shown in FIG. 1, one or more spring biasing or cushioning members 35 each includes a fastener 37 extended downward therefrom and threaded through the plate 32 of the motor 30 and the peripheral flange 27 of the housing 20, for securing the plate 32 and thus the motor 30 to the housing 20. The cushioning members 35 may be made of soft or resilient materials, such as rubber, gel, spongy materials or the like, and includes another fastener 38 extended upward therefrom for threading or securing to the other objects or elements. A circuit board 33 or the like and a knob 34 may be secured to the housing 20 or to the motor 30 or to the plate 32 and may be coupled to the motor 30 for controlling the motor 30. Alternatively, the motor 30 may also be controlled by a remote control device (not shown) or the like.

A board 40 is secured on top of the cushioning members 35 with the fasteners 38 or the like, and includes an orifice 41 formed therein. A casing 60 is secured on the board 40 with fasteners 43 or the like, such that the casing 60 and the board 40 move in concert with each other. A panel 50 is secured to the bottom of the casing 60 with fasteners 51 or the like, and includes a recess 52 formed therein for receiving a socket 53, and a bearing 54 or the like received in the socket 53. A cam or an eccentric member 55 includes an axle 56 extended therefrom and secured to the bearing 54 for rotatably securing the eccentric member 55 to the panel 50 and thus to the casing 60. The eccentric member 55 includes a protrusion 57 extended therefrom and received in the orifice 41 of the board 40. The spindle 31 of the motor 30 is secured to the eccentric member 55 for rotating the eccentric member 55 to generate a vibration to the board 40 and the casing 60. The casing 60 and the board 40 may be slightly moved or vibrated relative to the handle 10 and the housing 20 due to the cushioning members 35.

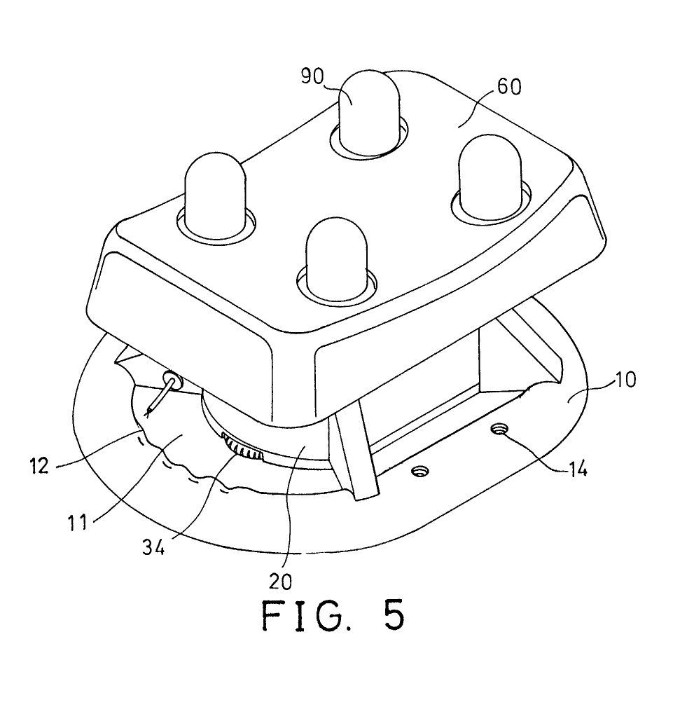

As shown in FIGS. 1, 4, the casing 60 includes one or more curved or concave surfaces 63 formed therein for engaging onto the legs or the back portion or the abdominal portion of the users, for example, and includes one or more cavities 61 and one or more screw holes 62 formed therein. As shown in FIG. 5, the fasteners 91 of the massaging members 90 may be selectively or detachably secured to the screw holes 62 of the casing 60 for selectively or detachably securing the massaging members 90 to the casing 60.

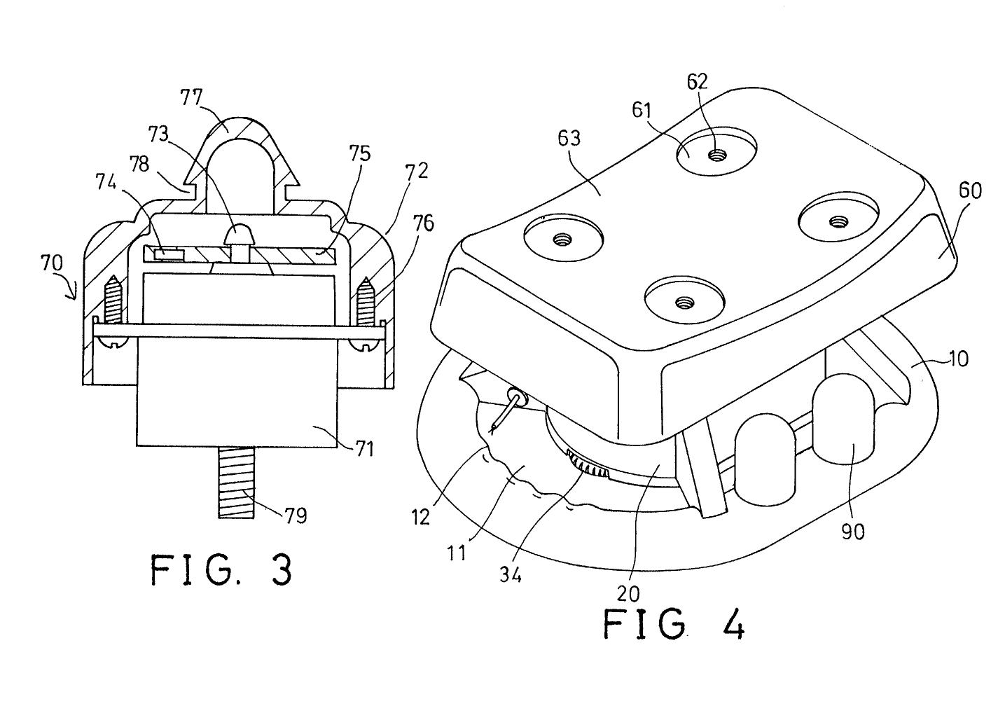

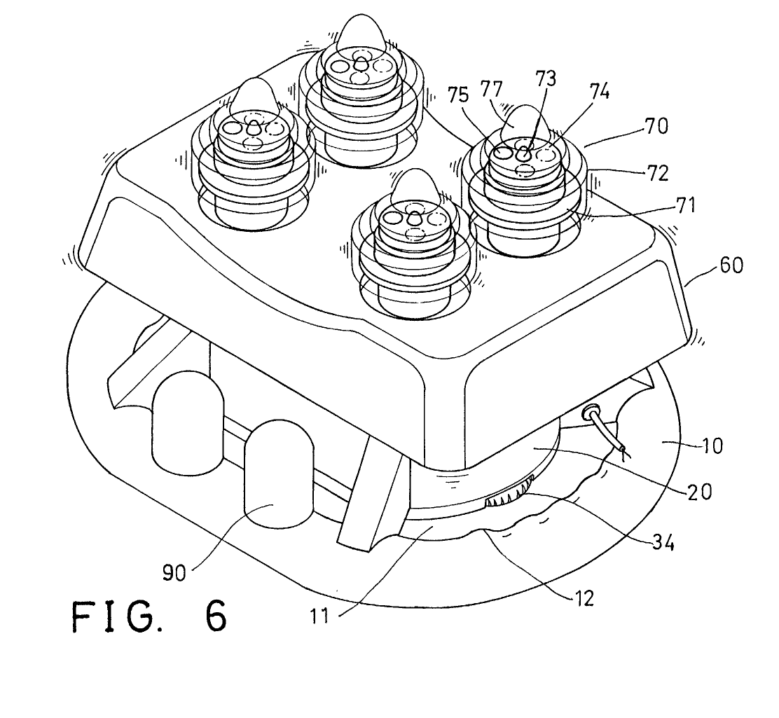

As shown in FIGS. 1-3 and 6, one or more further massaging members 70 each includes a block 71 having a fastener 79 extended therefrom for detachably threading and securing to the screw holes 14 of the handle device 10, or for detachably threading and securing to the screw holes 62 of the casing 60 (FIG. 6). The blocks 71 each includes a tip 73 for deeply engaging into the bodies of the users. A disc 74 is engaged onto the tip 73 and includes a magnetic member 75 engaged or secured therein. A cap 72 is secured onto the block 71 with fasteners 76 or the like and includes a rounded or enlarged head 77 provided thereon for comfortably engaging with various portions of the users. A neck portion or a peripheral groove 78 is formed between the enlarged head 77 and the cap 72 (FIG. 3).

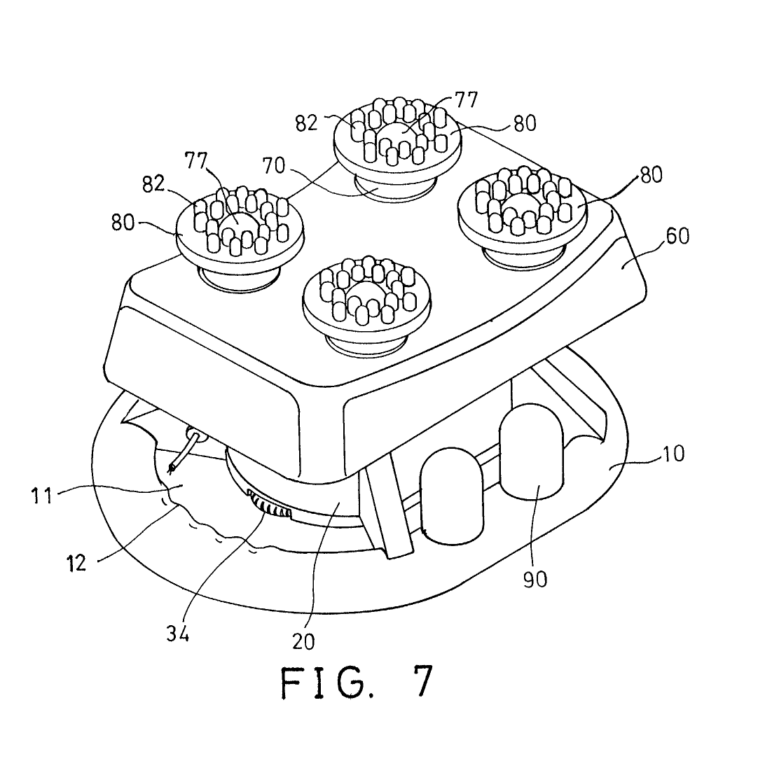

As shown in FIGS. 1 and 7, one or more still further massaging members 80 are further provided and each includes an aperture 81 formed therein for engaging onto the head 77 of the cap 72 of the massaging members 70, and each includes one or more spring-biased projections 83 extended therefrom for engaging into the peripheral groove 78 of the cap 72 and for selectively or detachably securing the massaging members 80 onto the caps 72 of the massaging members 70 respectively. The massaging members 80 each includes a number of pins or rods 82 extended therefrom for engaging with and for massaging various portions of the users.

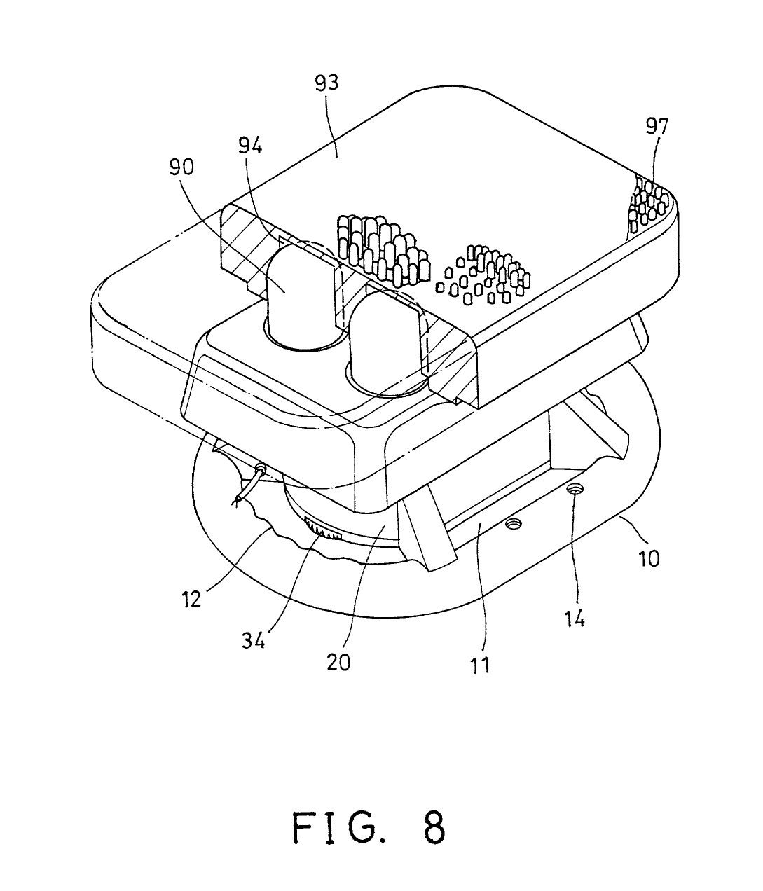

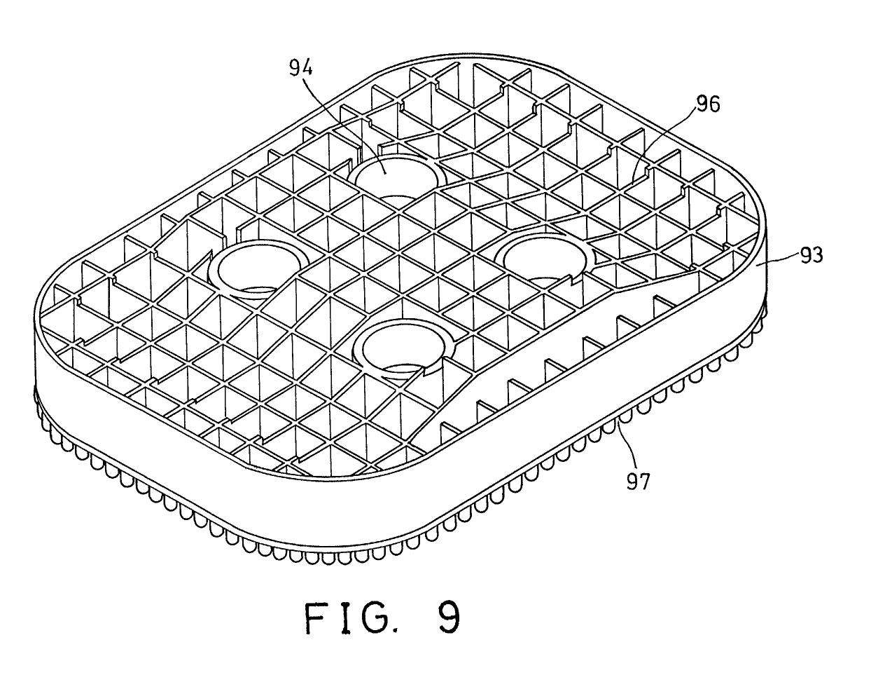

Referring next to FIGS. 8, 9 and again to FIG. 1, the massaging assembly further includes another massaging member 93 having one or more hubs 94 formed or provided on the bottom portion thereof for engaging onto or for securing onto the massaging members 90 with such as a force-fitted engagement. The massaging member 93 includes a number of reinforcing ribs or a spider web 96 formed in the bottom portion thereof and provided between the hubs 94 for reinforcing the hubs 94 and the massaging member 93, and includes a number of pins or rods 97 extended therefrom for engaging with and for massaging various portions of the users, such as for massaging the feet of the users.

In operation, as shown in FIGS. 4-8, the casing 60, and the massaging members 70, 80, 90, 93 may be selectively or detachably secured onto the board 40 and may be vibrated by the eccentric member 55 and the motor 30, for selectively massaging various portions of the users. The caps 72 of the massaging members 70 may also be disengaged from the blocks 71 of the massaging members 70 for allowing the tips 73 of the massaging members 70 to be selectively used for deeply engaging into the bodies of the users and for massaging the deeper portions of the users.

Accordingly, the massaging assembly in accordance with the present invention includes various kinds of massaging members for massaging various portions of the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massaging assembly comprising:
a first massaging member including an upper portion having a plurality of rods for engaging with and for massaging users, and including a bottom portion having a plurality of reinforcing ribs for reinforcing purposes, and
means for vibrating said first massaging member.

2. The massaging assembly according to claim 1 further comprising a handle device including a pair of hand grips provided therein.

3. The massaging assembly according to claim 2, wherein said handle device includes a peripheral structure having said hand grips provided therein and opposite to each other.

4. The massaging assembly according to claim 2, wherein said vibrating means includes a motor, an eccentric member secured to and driven by said motor, and means for securing said motor on said handle device.

5. The massaging assembly according to claim 4, wherein said securing means includes a housing secured on said handle device and having a chamber formed therein for receiving said motor.

6. The massaging assembly according to claim 5, wherein said handle device includes at least one depression formed therein, said housing includes at least one leg extended therefrom and engaged into said at least one depression of said handle device and secured to said handle device.

7. The massaging assembly according to claim 4, wherein said vibrating means includes a casing, and at least one cushioning member secured between said casing and said motor.

8. The massaging assembly according to claim 7, wherein said eccentric member includes an axle rotatably secured to said casing, and includes a protrusion extended therefrom, said motor includes a spindle secured to said eccentric member for rotating said eccentric member.

9. The massaging assembly according to claim 8, wherein said vibrating means includes a board secured to said casing and having an orifice formed therein for receiving said eccentric member.

10. The massaging assembly according to claim 7, wherein said casing includes at least one concave surface formed therein for engaging onto and for massaging the users.

11. The massaging assembly according to claim 7 further comprising at least one second massaging member detachably secured onto said casing.

12. The massaging assembly according to claim 11, wherein said at least one second massaging member includes a tip extended therefrom for deeply engaging into the users.

13. The massaging assembly according to claim 12, wherein said at least one second massaging member includes a block, and a cap selectively secured onto said block, said cap includes a head provided thereon for engaging with and for massaging the users.

14. The massaging assembly according to claim 13 further comprising at least one third massaging member selectively engaged onto said head of said cap and including a plurality of rods extended therefrom for engaging with and for massaging the users.

15. The massaging assembly according to claim 14, wherein said cap includes a peripheral groove formed therein, said at least one third massaging member includes at least one spring-biased projection extended therefrom for engaging into said peripheral groove of said cap and for detachably securing said at least one third massaging member onto said cap.

16. The massaging assembly according to claim 13, wherein said block includes at least one magnetic member disposed thereon.

17. The massaging assembly according to claim 11, wherein said first massaging member includes at least one hub provided in said bottom portion thereof for engaging onto said at least one second massaging member, said reinforcing ribs are engaged with said at least one hub.
